(19) United States
(12) Patent Application Publication
(10) Pub. No.: US 2025/0210990 A1
(43) Pub. Date: Jun. 26, 2025

(54) SUSTAINABLY INPUT PHASE BALANCING WITH INTELLIGENT PHASE ASSIGNMENT AND PSU LOAD SHIFTING

(71) Applicant: International Business Machines Corporation, Armonk, NY (US)

(72) Inventors: John S. Werner, Fishkill, NY (US); Luke L. Jenkins, Poughkeepsie, NY (US); Arkadiy O. Tsfasman, Wappingers Falls, NY (US); John Torok, Poughkeepsie, NY (US)

(21) Appl. No.: 18/389,968

(22) Filed: Dec. 20, 2023

(51) Int. Cl. H02J 3/14; G06F 1/18; G06F 1/30; G06F 11/30; H02J 3/26; H02J 13/00

(52) U.S. Cl. CPC H02J 3/144; G06F 1/189; G06F 1/305; G06F 11/3062; H02J 3/26; H02J 13/00002; H02J 13/00004; H02J 13/00034; H02J 2310/20; H02J 2310/60

(57) ABSTRACT

A system and related method balance phase power in a power distribution system. The method comprises performing the following operations dynamically and repeatedly, during operation of subcomponents receiving power from a plurality of redundant intelligent PDUs. Input phases of the intelligent PDUs are monitored for power values associated with the input phases that provide power to the subcomponents through the PDUs. A target per-phase power value is determined. When the input phases are not balanced, an input phase at an input port is redirected to an output port of at least one of the PDUs using a switch to bring the not-balanced phases closer to being balanced phases by reducing a difference of phase powers to the target per-phase power value. The method then comprises performing load shifting on the power supply units (PSUs) associated with the redundant PDUs to improve an overall phase power balance across all redundant PDUs.

### BACKGROUND

A system and method are described below for input phase balancing of power distribution units (PDUs) in a power distribution system by using intelligent phase assignment implemented with a phase-switchable PDU that can further perform PSU load shifting.

Power distribution is an important factor in providing computer-based services to clients, particularly to help ensure safety, security, efficiency of operation, and availability of applications and data. There are many components involved in ensuring such safety, security, efficiency, and availability. With regard to efficiency, it is important for data centers and other computer-intensive operations to use and distribute power in an efficient manner. This includes balancing power on input phases of a multi-phase system that is provided to various components that are used to provide computing and data resources to clients.

When power on input phases of a multi-phase system are unbalanced within an equipment rack, the components are subjected to additional stresses and limitations that can be avoided when a similar overall power is distributed more evenly. Additionally, unbalanced phases within an equipment rack leads to unbalanced phases on the power source supplying power to multiple equipment racks (including the equipment rack with unbalanced phases) which wastes power due to I²R distribution effects. By way of a simple example, in a three-phase system, an equipment rack may draw an overall power of 9 kW, which, if balanced properly, is broken down into 3 kW on each of the phases. If components are instead powered from only two of those phases, then the 9 kW is unevenly balanced (e.g., 5 kW on a first phase, 4 kW on a second phase, and 0 kW on the third phase) with the equipment rack with the two loaded phases being operated near their operational limits. If the 9 kW load can be evenly distributed between all three phases, then each phase is operating within its rated capacity, which can reduce stress on components within the equipment rack, reduce stress on existing infrastructure (e.g., power source supplying power to the equipment rack), and allow additional bandwidth for additional capacity within the equipment rack.

### SUMMARY

Disclosed herein is a method for balancing phase power in a power distribution system. The method comprises performing the following operations dynamically and repeatedly, during operation of subcomponents receiving power from a plurality of redundant intelligent PDUs. The method comprises monitoring a plurality of input phases of the intelligent PDUs for power values associated with the input phases that provide power to the subcomponents through the PDUs. The method then comprises determining target per-phase power value based on the input phase power values by summing a total input power to each PDU in the redundant set of PDUs and dividing the summed total input power by a number of the phases. The method further comprises determining when the input phases are not balanced according to a predefined threshold or rule that uses the target per-phase power value, and redirecting an input phase at an input port to an output port of at least one of the PDUs using a switch on the at least one PDU to bring the not-balanced phases closer to being balanced phases by reducing a difference of phase powers to the target per-phase power value. A first phase of at least one of the PDUs connected to a first subcomponent differs from a second phase of a redundant PDU connected to the first subcomponent. The method then comprises performing load shifting on the power supply units (PSUs) associated with the redundant PDUs to achieve an overall improved input phase power balance across all redundant PDUs.

Disclosed herein is also a system for balancing phase power in a power distribution system, comprising a memory, and a processor that is configured to dynamically and repeatedly perform the following operations, during operation of subcomponents receiving power from a plurality of redundant intelligent PDUs. The processor is configured to monitor a plurality of input phases of the intelligent PDUs for power values associated with the input phases that provide power to the subcomponents through the PDUs. The processor is further configured to determine target per-phase power value based on the input phase power values by summing a total input power to each PDU in the redundant set of PDUs and dividing the summed total input power by a number of the phases. The processor is further configured to determine when the input phases are not balanced according to a predefined threshold or rule that uses the target per-phase power value, and redirect an input phase at an input port to an output port of at least one of the PDUs using a switch on the at least one PDU to bring the not-balanced phases closer to being balanced phases by reducing a difference of phase powers to the target per-phase power value. A first phase of at least one of the PDUs connected to a first subcomponent differs from a second phase of a redundant PDU connected to the first subcomponent. The processor is then configured to perform load shifting on the power supply units (PSUs) associated with the redundant PDUs to achieve an overall improved input phase power balance across all redundant PDUs.

A computer program product is also provided for balancing phase power in a power distribution system, the computer program product comprising one or more computer readable storage media, and program instructions collectively stored on the one or more computer readable storage media, the program instructions comprising program instructions to perform the above-described method when executed on one or more processors.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1A is a block diagram of a general computing device and environment, according to some embodiments.

FIG. 1B is a block network diagram that illustrates various components for a data center system (DCS) that utilizes an example of a novel dynamic PDU phase switching system (PPSLSS) for improved power efficiency using intelligent phase assignment, according to some embodiments.

FIG. 1C is a block diagram illustrating example equipment racks illustrating the PDUs with 2N redundancy, according to some embodiments.

FIG. 2 is a schematic block diagram describing some embodiments of an example wye-configured PDU illustrating phase switches, according to some embodiments.

FIG. 3 is a schematic block diagram similar to FIG. 2A, but describes some embodiments of an example delta-configured PDU illustrating phase switches, according to some embodiments.

FIG. 4 is a flowchart illustrating an example process for phase balancing using intelligent phase assignment and PSU load shifting, according to some embodiments.

FIGS. 5A-5C are block diagrams of a wye-configured PDU that illustrate various switch configurations for such a wye-connected power supply.

FIGS. 6A-6C are block diagrams of a delta-configured PDU that illustrate various switch configurations for such a delta-connected power supply.

### DETAILED DESCRIPTION

The following general acronyms may be used below:

TABLE 1
General Acronyms

| | |
|---|---|
| CD-ROM | compact disc ROM |
| CPP | computer program product |
| DVD | digital versatile disk |
| EPROM | erasable programmable read-only memory |
| EUD | end-user device |
| IoT | Internet of Things |
| LAN | local-area network |
| NFC | near field communication |
| RAM | random access memory |
| ROM | read-only memory |
| SAN | storage area network |
| SD | secure digital |
| SDN | software-defined networking |
| SRAM | static random-access memory |
| UI | user interface |
| USB | universal serial bus |
| VCE | virtual computing environment |
| WAN | wide-area network |

### Data Processing System in General

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

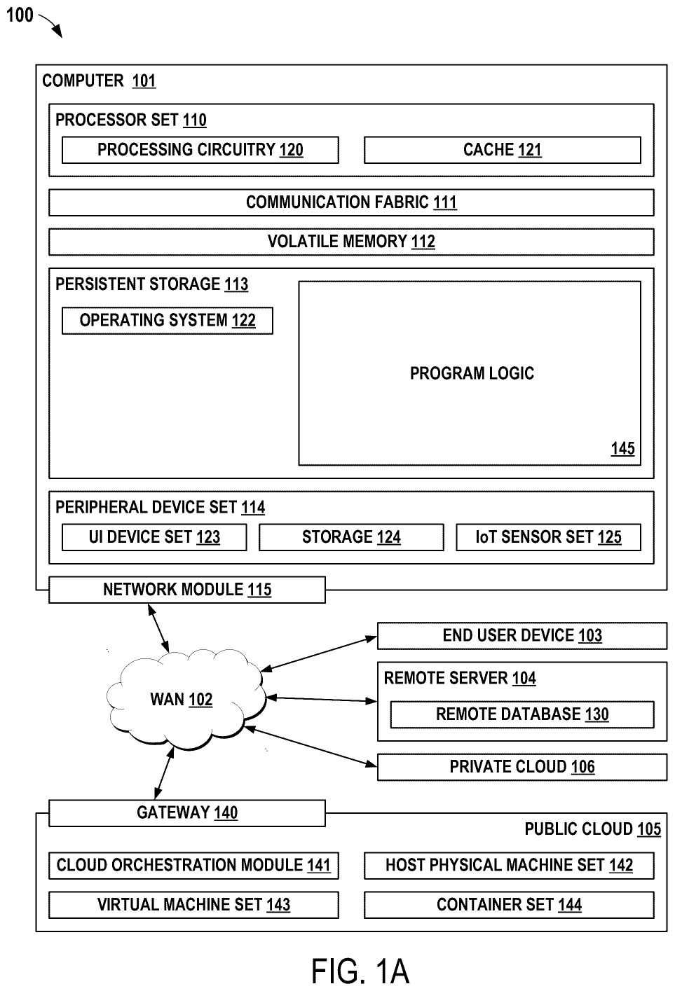

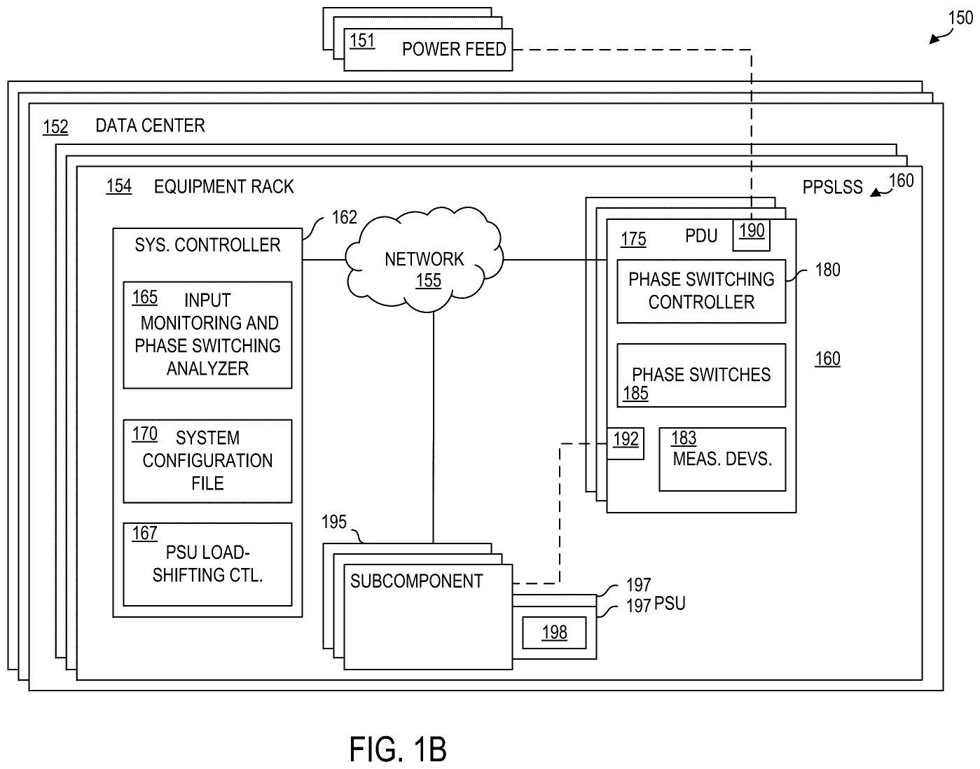

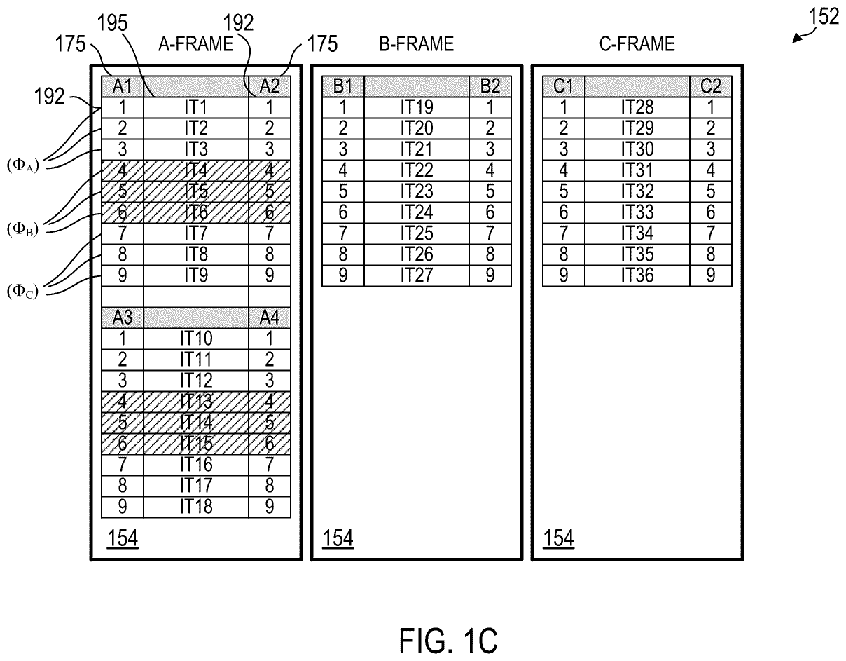

FIG. 1 is a block diagram of a general computing device and environment. Computing environment 100 contains an example of an environment for the execution of at least some of the computer code involved in performing the inventive methods disclosed herein, including program logic 145 that may be implemented in various combinations of hardware and/or software described below. In addition to the program logic 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program logic 145, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the program logic 145 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the program logic 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein has been chosen to best explain the principles of the embodiments, the practical application or technical improvement over technologies found in the marketplace, or to enable others of ordinary skill in the art to understand the embodiments disclosed herein.

Certain reference numbers or characters may be represented as being pluralities (e.g., 100.1, 100.2, etc.). In such instances, reference to a single reference number (e.g., 100) may represent the plurality of entities, or may represent an example of the set, depending on the context. This similarly applies to reference numbers or characters that use subscripts.

Sustainably Input Phase Balancing with Intelligent Phase Assignment and PSU Load Shifting

The following application-specific acronyms may be used below:

TABLE 2A
Application-Specific Acronyms

| | |
|---|---|
| BMC | baseboard management controller |
| DCIM | data center infrastructure management |
| DCS | data center system |
| iPDU | intelligent power distribution unit |
| PDU | power distribution unit |
| PPSLSS | PDU phase switching and load shifting system |
| PSU | power supply unit |
| SPST | single-pole-single-throw (switch) |
| UPS | uninterruptable power supply |

TABLE 2B
Table of Reference Numbers

| | |
|---|---|
| 100 | computing environment |
| 101 | computer |
| 102 | wide area network (WAN) |
| 103 | end user device (EUD) |
| 104 | remote server |
| 105 | public cloud |
| 106 | private cloud |
| 110 | processor set |
| 111 | communication fabric |
| 112 | volatile memory |
| 113 | persistent storage |
| 114 | peripheral device set |
| 115 | network module |
| 120 | processing circuitry |
| 121 | cache |
| 122 | operating system |
| 123 | device set |
| 124 | storage |
| 125 | IoT sensor set |
| 130 | remote database |
| 140 | gateway |
| 141 | cloud orchestration module |
| 142 | physical machine set |
| 143 | virtual machine set |
| 144 | container set |
| 145 | program logic |
| 150 | data center system (DCS) |
| 151 | power feed |
| 152 | data center |
| 154 | equipment rack |
| 155 | equipment rack network |
| 160 | PDU phase switching and load shifting system (PPSLSS) |
| 162 | system controller |
| 165 | input monitoring and phase switching analyzer |
| 167 | PSU load shifting control |
| 170 | system configuration file |
| 175 | power distribution unit (PDU) |
| 180 | phase switching controller |
| 183 | power measuring device |
| 185 | phase switches |
| 190 | PDU input port |
| 192 | PDU output port |
| 195 | subcomponent |
| 197 | power supply unit (PSU) |
| 198 | PSU load shifter |
| 400 | method/process |
| 410-450 | process operations |

Properly balancing power on input phases of a multi-phase power system can help to alleviate stresses and limitations that can otherwise be present when the power is not balanced. Unbalanced phases within an equipment rack leads to unbalanced phases on the power source supplying power to multiple equipment racks (including the equipment rack with unbalanced phases) which wastes power due to I²R distribution effects. Distributing power evenly between phases can allow each phase to operate within its rated capacity, thereby reducing stress on components within the equipment rack, reducing stress on existing infrastructure, and allowing additional bandwidth for additional capacity within the equipment rack.

To optimize the balance of phased power distribution within a power distribution system, which may be an equipment rack comprising a plurality of PDUs, disclosed herein are various embodiments of a system and method for balancing phased power. In general, the method involves initially looking at the power of all of the subcomponents in a given equipment rack, determining the best switch configurations for PDUs to best balance the phases for a set of PDUs without (initially) performing any load shifting. Once this is done, the method then looks at the system as a whole (this may refer to the power in a particular equipment rack, but could easily be generalized to include multiple equipment racks within a data center or units sharing a common source of phased power) to determine which phases the subcomponents are on and potentially perform PSU load shifting.

The purpose behind considering doing phase switching prior to performing PSU load shifting is illustrated by the following situation. If one component is connected to two PSUs and these two PSUs are connected to two different PDUs, performing a PSU load shift for PSUs when they are both connected to the same phase of their respective PDUs does not help to balance the phase power at the ultimate source of power/power feed. The PSU load shift may occur, but it is a load shift that occurs within a same phase and does not achieve the aim of overall phase balancing.

Having unbalanced PDU input phases wastes power (due to I²R distribution effects) and limits utilization of three-phase power sources. This may lead to exceeding various criteria, such as line cord ratings on individual phases, creating problems such as failing product safety compliance standards, excessive heating in cables/connectors/relays/circuit breakers, and tripping upstream circuit breakers. Without a monitoring of PDU input line power to determine if an input phase line is unbalanced with respect to other phases, the ability to perform power balancing on the input phases of a PDU is not possible.

Some existing systems with redundant PDUs may have mirrored plugging on each side of the system so it is not possible to simply shift power within a component to achieve PDU phase balancing on both sides of the system. This is because balancing phases on one side of the system within a first PDU of the redundant set of PDUs with PSU load shifting will further unbalance phases on a second PDU of the redundant set of PDUs which could lead to worse cumulative losses within the equipment rack. Moreover, these existing systems that utilize PSU load shifting only do not have any impact on the power losses at the power feed if that power feed is supplying power to all of the PDUs in the redundant set of PDUs because the same total power still remains on each of the power feed output phases. Thus, before performing the PSU load shifting, and in order to benefit from it, the respective power feeds must be on different phases.

In various embodiments disclosed herein, a system is provided that performs intelligent phase assignment within the PDUs and performs PSU load balancing within subcomponents to optimally balance PDU input phase power throughout the entire system. The system may monitor all input phase currents and output port load currents that distribute power to each PSUs. In some embodiments, the PDUs (some, all, but preferably at least half) have internal switches (e.g., in the form of transistors, relays, circuit breakers, and similar switching devices) that can connect any of the input lines to any of the output ports for the drawers/subcomponents.

The switching determinations may be made by summing the total power in a PDU, then checking the system configuration file to determine if there are other PDUs that the subcomponents are hooked up to. From that, a PDU switch configuration is determined to get as close to an optimal balancing as possible. Once this is complete, a PSU load shifting is performed to further dial in the power balancing. This is a dynamic (operating in real-time) and an iterative (looping/repeating/refining) process, since the load of all of the subcomponents in a rack may be constantly changing, depending on an operational status.

In a typical implementation, the rate of performing an iteration might range from a couple of times per hour to a couple of times per day, although this frequency may be situation dependent. A typical system tends to require a fairly consistent power from one drawer to the next after an initial configuration is established and a power on occurs, although there may be patterns of activity that may dictate the frequency of the iterations—for example, night-time activity may differ from day-time activity. The determinations, switch changes, and PSU balancing may take, for example, on the order of millisecond to achieve, and a hold-up of PSU capacitance may be relied upon to not drop power to a subcomponent during the change.

The intelligent PDU disclosed herein comprises switches capable of rearranging which of its input phases connect to which of its output ports. These switches allow for a flexibility in helping to balance power distribution. The PSUs are configured to provide load shifting across PSUs. The combination of the two in a unique way allows the system to best balance the inputs phases across all PDUs within a redundant set of PDUs within an equipment rack.

In some embodiments, PDU phase assignments are used to get input line powers (phases) close to balanced, and then algorithmically make smaller load adjustments using PSU load shifting. The system sums the total input power to each PDU and divides the total input power by the number of input phases to determine optimal power level on each phase for perfect input phase balancing.

In some embodiments, the system disclosed herein adjusts PSU loads (unbalanced within the subcomponents) on each subcomponent to get as close as possible to a target power value for PDU phase inputs determined after the sum, divide operation, and switching operations.

FIG. 1B is a block network diagram that illustrates various components for a data center system (DCS) 150 that utilizes an example dynamic PDU phase switching system (PPSLSS) 160 for improved power efficiency using intelligent phase assignment, according to some embodiments. In FIG. 1B, dashed lines represent power distribution and solid lines represent data communication. The DCS 150 contains one or more power feeds 151 and one or more data centers 152. The power feeds 151 provide power to PDUs 175 within the data center 152 and possibly to a plurality of uninterruptible power supplies (UPSs) (not shown). As disclosed herein, the power feed may come from any source and include possibly UPSs.

In some embodiments, the data communications to the subcomponent 195 for load shifting of the PSUs 197 comes from the system controller 162. The PSUs 197 may comprise PSU load shifter 198, which may comprise hardware and software, that shifts the load based on information received from the PSU load shifting control 167. The PSU load shifting control 167 may determine what amount of balancing percentages are needed, and then send a signal to the PSUs 197 associated with the subcomponent(s) 195 to alter the power balance. Although shown contained within the PSU 197, portions of the PSU load shifter 198 may be physically located outside of the PSU 197 (e.g., within a microcontroller of subcomponent 195) and interface with the PSU 197 for power control.

DCS components may be provided within equipment racks having a plurality of drawers (also referred to herein as “equipment racks”) in which various components are provided (the physical structure and naming conventions used here are by way of example, and other architectural arrangements may be considered as a part of the invention as well). Various embodiments of the disclosure may be most beneficial when an equipment rack is not fully-loaded with components—such a configuration runs a greater risk of an imbalance between the phases.

The data center 152 may contain a plurality of equipment racks 154 (and possibly optional UPSs that may provide emergency power to a load (e.g., PDUs 175 of equipment racks 154) when the input power source (e.g., power feed 151) fails). The equipment rack 154 may comprise a system controller 162, one or more power distribution units (PDUs) 175, and one or more subcomponents 195 interconnected via a wired and/or wireless equipment rack network 155. The subcomponents 195 may be servers, I/O drawers, switches, etc. For a system in which there is a single PDU 175, it is possible to change the phase that connects to each PSU 197 within the same subcomponent 195, and then perform PSU 197 load shifting to balance the input phases to the single PDU 175.

The system controller 162 may be implemented as a computer 101, as described above. Any of the program logic 145 described herein may be implemented in any combination of software and hardware that is used to operate any or all of the system controller 162, the PDU 175, the PSU 197, or any other components of the PPSLSS 160. Components and functionality of the PPSLSS 160 may be integrated with the system controller 162, the PDU 175, and/or the PSU 197. In one or more embodiments, the equipment racks 154 represent (contain) a single server or mainframe computer (a system) and its associated subcomponents. In some embodiments, such a system may be spread out over multiple equipment racks 154. In some embodiments, an equipment rack 154 may comprise multiple systems and associated components. These configurations may be mixed (systems and their relationships to equipment racks).

The wired and/or wireless equipment rack network 155 may utilize any communication protocol that allows data to be transferred between components of the system (e.g., PCIe, I²C, Bluetooth, Wi-Fi, Cellular (e.g., 3G, 4G, 5G), Ethernet, fiber optics, etc.).

The subcomponents 195 may be any type of a server drawer and/or component (e.g., processor drawer, IO drawer, ethernet switch, radiator, etc.) that receives output power from the one or more PDUs 175. In one or more embodiments, the subcomponents 195 have redundant power inputs (e.g., contain two or more PSUs 197). In one or more embodiments, the subcomponents 195 are not part of the equipment rack 154 (e.g., may be located on a shelf, table, etc.).

The system controller 162 may contain input monitoring and phase switching analyzer 165, the PSU load shifting control 167, and system configuration file 170. In one or more embodiments, the system controller 162 may be located on the service element (SE) of an equipment rack 154. In one or more embodiments, the system controller 162 may be located on a baseboard management controller (BMC) of an equipment rack 154. In one or more embodiments, the system controller 162 is part of a data center infrastructure management (DCIM) system (e.g., Cormant-CS®, EkkoSense®, Sunbird®, etc.) and may be located outside of the equipment rack 154. In some embodiments, a DCIM is located within each datacenter 152.

In some embodiments, the system controller 162 may be inside one or more of the data centers 152 and in some embodiments, the system controller 162 may be outside of the data center 152. In some embodiments, the DCIM may be a system that monitors/controls multiple datacenters (i.e., part or all of the DCS 150). In one or more embodiments, the system controller 162 is contained within one or more of PDUs 175.

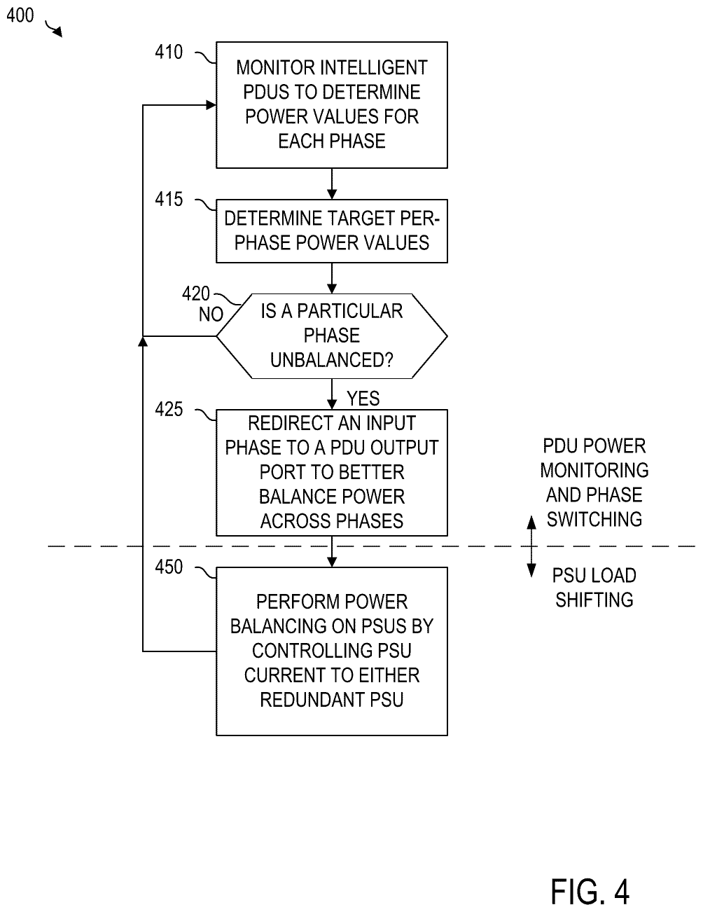

The input monitoring and phase switching analyzer 165 may comprise monitoring components that monitor the input power signals (using, e.g., the power measuring device 183 of the PDU 175) at the PDU input port 190 of the one or more PDUs 175. These input signals may include, but are not limited to, current, voltage, and power. The input monitoring and phase switching analyzer 165 may further comprise analysis tools for analyzing these input signals and making a determination as to whether phase switching is required or beneficial for balancing. This determination may be made by performing the process 400 described in FIG. 4 below. The phase switches 160 may be switched to adjust the phase balance, and then load shifting may be performed on the PSUs 197 to optimize the input phase balancing of the overall system (or balancing all of the PDUs 175 that are being supplied by a single power feed 151).

The input to the input port 190 is the input to the PDU 175 from the power feed 151 that is measured by the power measuring device 183 and monitored by the input monitoring and phase switching analyzer 165 of the system controller 162.

The phase power for each subcomponent 195 may be determined in various ways. In one embodiment, the PDU output power per output port may be measured by the measuring device 183. In another embodiment, the PSU input power may be measured by a similar measuring device (i.e., similar to measuring device 183) on the PSU 197. The input monitoring and phase switching analyzer 165 may provide any further associated power calculations, if needed. The tables below illustrate power values that may be obtained using any of these techniques. Any of these techniques may be used for “power monitoring of the PDU”.

Alternately, the system configuration file 170 and various rules contained therein may at least provide a basis for making these determinations in the event that actual measurements are not possible. The system configuration file 170 may contain the system or the DCS 150 rules. These may include, e.g., plug rules (such as those that might correspond to the layout in FIG. 1C) and power supply redundancy information.

By way of a first example, the file 170 may contain a single two-unit (2U) server model that has two PSUs with 2N redundancy. The file may contain data related to PDU output ports 192 that connect to the two server inputs. By way of a second example, the file 170 may contain subcomponent data related to a server that uses four equipment racks 154, that contains four processor drawers, ten IO drawers, two radiators, four ethernet switches, two service elements, and eight PDUs. The file 170 in these examples would contain information on all the PDU output plug information to all of these subcomponents. In these two examples, the measurements from the measurement devices 183, may be provided to the input monitoring and phase switching analyzer 165 and may be used to determine if phase switching is needed based on the system plug configuration and whether PSU load shifting is required.

The PSUs 197 may receive power input from the PDU 175 and provide power to the subcomponent 195. The PSUs 197 may also comprise the load shifter 198 that receives information from the PSU load shifting control 167 that allows controlling the output power of the PSU 197 to permit the load to be shifted. This is in contrast to the normal situation in which the subcomponent 195 draws the same amount of power from each of the PSUs 197. With the load shifting, the power on one PSU 197 is lowered and the power on another PSU(s) is raised.

FIG. 1C is a block diagram illustrating three example equipment racks 154 (A-Frame, B-Frame, C-Frame) and the PDUs 175 (A1-A4, B1, B2, C1, and C2). The PDUs 175 are organized with 2N redundancy as illustrated, but, as noted above, additional PDUs 175 could also be utilized as well. Thus, each of the subcomponents 195 (IT1-IT36) interfaces with PDU output ports 192 from two or more different PDUs 175 (e.g., A1 and A2). As shown in FIG. 1B, but not FIG. 1C, each of the PDUs 175 comprises two or more PSUs 197 (two are shown in FIG. 1B). Plug rules that are stored in the system configuration file 170 may contain a data mapped description of the organization shown in FIG. 1C.

### Example Use Cases

In sum, according to various embodiments, in response to a determined phase imbalance in delivering power, the PDU output ports 192 may be reassigned, using switches 185 on the PDU 175 to provide a more evenly-distributed input phase power. By way of illustrative example, FIG. 1C shows an equipment rack 154 having redundant PDUs 175 (PDU-A1, and PDU-A2) connected to drawers for the subcomponents 195 (IT1-IT9). In this example, drawers for subcomponents 195 IT1-IT3 are connected to Φ_{A} in a three-phase system, drawers for subcomponents 195 IT4-IT6 are connected to Φ_{B}, and drawers for subcomponents 195 IT7-IT9 are connected to Φ_{C}.

The following tables illustrate power and phase values based on various subcomponent 195 and phase switching configurations. Example values are provided for illustrative purposes, but these values could be scaled appropriately for any type of real-world configuration.

In one example situation in which the rack 154 is full of subcomponents, the power (in watts) drawn by these subcomponents with the switch configuration listed above is shown in Table 3A below:

TABLE 3A
Power Consumption/Limits for Fully-Loaded Equipment Rack

| | | | | | | | | | | PSU load |
|---|---|---|---|---|---|---|---|---|---|---|
| | | | | Power | | Φ | Power | Φ | | balance |
| Total | | | Power | per | | connection | per port | connection | | (PDU-A1 |
| 3Φ | | | per | port on | PDU- | on | on | on | PDU- | PSU/PD |
| rack | Power | Sub- | sub- | PDU- | A1 | PDU- | PDU- | PDU- | A2 | U-A2 |
| power | per Φ | comp. | comp | A1 | port | A1 | A2 | A2 | port | PSU) |
| 14400 | 4200 | IT1 | 2500 | 1250 | 1 | A | 1250 | A | 1 | 50%/50% |
| | (Φ_{A}) | IT2 | 1600 | 800 | 2 | A | 800 | A | 2 | 50%/50% |
| | (29.2%) | IT3 | 100 | 50 | 3 | A | 50 | A | 3 | 50%/50% |
| | 5100 | IT4 | 100 | 50 | 4 | B | 50 | B | 4 | 50%/50% |
| | (Φ_{B}) | IT5 | 2500 | 1250 | 5 | B | 1250 | B | 5 | 50%/50% |
| | (35.4%) | IT6 | 2500 | 1250 | 6 | B | 1250 | B | 6 | 50%/50% |
| | 5100 | IT7 | 100 | 50 | 7 | C | 50 | C | 7 | 50%/50% |
| | (Φ_{C}) | IT8 | 2500 | 1250 | 8 | C | 1250 | C | 8 | 50%/50% |
| | (35.4%) | IT9 | 2500 | 1250 | 9 | C | 1250 | C | 9 | 50%/50% |

In the example of Table 3A, the power between the phases is fairly well-balanced. The total power of the subcomponents 195 (14.4 kW) is nearly evenly distributed among the phases, although each phase is a little off of the ideal (total power/number of phases), which here would be 4.8 kW/phase. However, the inventive aspects described herein could still improve on even such slight imbalances—Table 3D illustrates such improvement by the use of changing PDU phase switches 185 and PSU load balancing. Table 3A illustrates an example snapshot of the power used and measured at a particular instant in time. The usage of power over time will vary based on the workload of the subcomponents 195, and hence the iterative approach described above may be utilized to repetitively measure and adjust the PDU switches and PSU load balancing during operation. Table 3D, below, shows the effect on these values after applying the PSU load balancing.

Table 3B illustrates a situation in which a configuration is selected that does not include the top two subcomponents 195 (i.e., the top two drawers plugged into output ports 1 and 2 192 are not populated). In this configuration, a far greater imbalance occurs. Phase A is used for very little of the total needed power, and the majority of the power is concentrated into Phase B and Phase C. In the Table 3B configuration, the ideal power per phase would be 3.433 kW/phase.

TABLE 3B
Power Consumption/Limits for Partially-Loaded Equipment Rack
Pre-Move (Pre-Switch)

| | | | | Power | | | Power | | | |
|---|---|---|---|---|---|---|---|---|---|---|
| | | | | per | | | per | | | PSU load |
| Total | | | Power | port | | Φ | port | Φ | | balance |
| 3Φ | | | per | on | PDU- | connection | on | connection | PDU- | (PDU-A1 |
| rack | Power | Sub- | sub- | PDU- | A1 | on PDU- | PDU- | on PDU- | A2 | PSU/PDU- |
| power | per Φ | comp. | comp | A1 | port | A1 | A2 | A2 | port | A2 PSU) |
| 10300 | 100 | | | | 1 | | | | 1 | |
| | (Φ_{A}) | | | | 2 | | | | 2 | |
| | (0.97%) | IT3 | 100 | 50 | 3 | A | 50 | A | 3 | 50%/50% |
| | 5100 | IT4 | 100 | 50 | 4 | B | 50 | B | 4 | 50%/50% |
| | (Φ_{B}) | IT5 | 2500 | 1250 | 5 | B | 1250 | B | 5 | 50%/50% |
| | (49.51%) | IT6 | 2500 | 1250 | 6 | B | 1250 | B | 6 | 50%/50% |
| | 5100 | IT7 | 100 | 50 | 7 | C | 50 | C | 7 | 50%/50% |
| | (Φ_{C}) | IT8 | 2500 | 1250 | 8 | C | 1250 | C | 8 | 50%/50% |
| | (49.51%) | IT9 | 2500 | 1250 | 9 | C | 1250 | C | 9 | 50%/50% |

In this situation, the input monitoring and phase switching analyzer 165 may determine that to better balance the power across the phases, it could “move” a subcomponent 195 (i.e., by changing the phase switches 185, and not by physically moving the plug location on the PDU 175) and perform PSU load balancing in order to better balance the power distribution across phases, as illustrated in Table 3C below.

TABLE 3C
Power Consumption/Limits for Partially-Loaded Equipment Rack
Post-Move (Post-Switch) (Load Shifted)

| | | | | Power | | | Power | | | |
|---|---|---|---|---|---|---|---|---|---|---|
| | | | | per | | | per | | | PSU load |
| Total | | | Power | port | | Φ | port | Φ | | balance |
| 3Φ | | | per | on | PDU- | connection | on | connection | PDU- | (PDU-A1 |
| rack | Power | Sub- | sub- | PDU- | A1 | on PDU- | PDU- | on PDU- | A2 | PSU/PDU- |
| power | per Φ | comp. | comp | A1 | port | A1 | A2 | A2 | port | A2 PSU) |
| 10300 | 3433 | | | | 1 | | | | 1 | |
| | (Φ_{A}) | | | | 2 | | | | 2 | |
| | (33.33%) | IT3 | 100 | 33 | 3 | A | 67 | C | 3 | 33%/67% |
| | 3433 | IT4 | 100 | 50 | 4 | A | 50 | C | 4 | 50%/50% |
| | (Φ_{B}) | IT5 | 2500 | 1250 | 5 | B | 1250 | A | 5 | 50%/50% |
| | (33.33%) | IT6 | 2500 | 750 | 6 | B | 1750 | A | 6 | 30%/70% |
| | 3434 | IT7 | 100 | 58 | 7 | B | 42 | C | 7 | 58%/42% |
| | (Φ_{C}) | IT8 | 2500 | 1125 | 8 | C | 1375 | B | 8 | 45%/55% |
| | (33.33%) | IT9 | 2500 | 350 | 9 | A | 2150 | C | 9 | 14%/86% |

Table 3C shows the result of moving various subcomponent 195 to being supplied by different phases, and additionally to make use of the PSU load balancing. By the use of the techniques disclosed herein, a nearly perfect power balance across phases may be achieved.

Advantageously, the movement to a different phase may be done using the phase switches 185 of the PDU 175 while maintaining the subcomponents 195 in the same physical rack position and plugged into the same PDU output port 192. The measuring device(s) 183 is able to determine measurements that may include the voltage and the current used by each of the subcomponents 195, and hence, determine the power load on each phase. The input monitoring and phase switching analyzer 165 may take these measurements, determine the necessary switching, and provide the switching information to the phase switching controller 180. Thus, the “movement” of the subcomponents 195 to different phases is the result of the input monitoring and phase switching analyzer 165 working in cooperation with the phase switching controller 180 and the phase switches 185, as described above, and additionally by use of the PSU load balancing, which may provide a refinement to the balancing beyond the mere switching of phases using the phase switches 185.

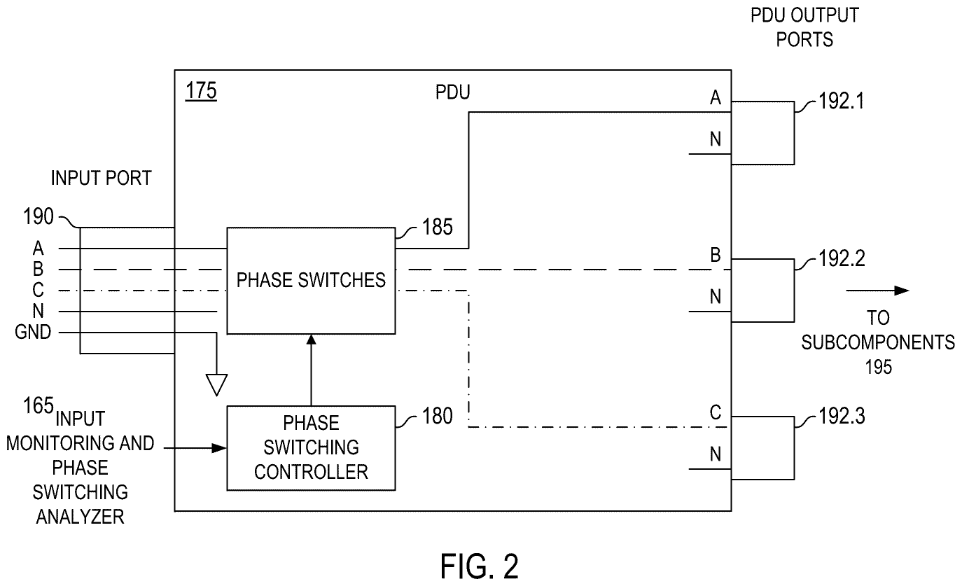

FIG. 2 is a schematic block diagram describing some embodiments of an example wye-configured PDU 175 illustrating phase switches 185. As described above, the PDU 175 receives the three-phase power (phases A, B, and C) via its input port 190. The measuring device 183 is able to measure the voltage and current for each of the phases at the input port 190 and for each of the output ports 192 and communicate them to the input monitoring and phase switching analyzer 165 and PSU load shifting control 167, which can thus determine the power at each output port 192. In alternate embodiments, output port power is not monitored in the PDU 175 and is instead monitored at input ports of the PSUs 197 within subcomponents 195. A determination may be made by the input monitoring and phase switching analyzer 165 as to whether a re-balancing of the phases to specific subcomponents 195 would be beneficial in balancing out the power between the phases. A determination may also be made by the PSU load shifting control 167 as to whether a load shifting between PSUs 197 of specific subcomponents 195 would be beneficial in balancing out the power between the input phases.

In the event that a re-balancing is in order, the phase switching controller 180 can direct the phase switches 185 to redirect a particular phase at the input port 190 to a specific output port 192. Although three ports 192.1, 192.2, 192.3 are shown in FIG. 2A, the configuration of FIG. 1C may have any number of output ports 192, where, in some embodiments, any input phase at the input port 190 can be directed to any output port 192. In FIG. 1C, each PDU 175 has nine output ports. Additionally, ground may also be connected to each of the output ports (not shown).

Advantageously, the input monitoring and phase switching analyzer 165 can monitor power usage in real-time, and various heuristics may be determined based on historical usage of the various subcomponents 195. The real-time data from the input monitoring and phase switching analyzer 165 may be used by the phase switching controller 180 to activate the phase switches 185 in real-time to adapt to active changes during operation of the PDU 175. Thresholds for activating the switches may be based on current measurements, predetermined criteria, and/or may be based on learned heuristics based on historical data using machine learning techniques. Further changes may be made using PSU load shifting to better balance the phases at the input port 190 after phase switching is performed.

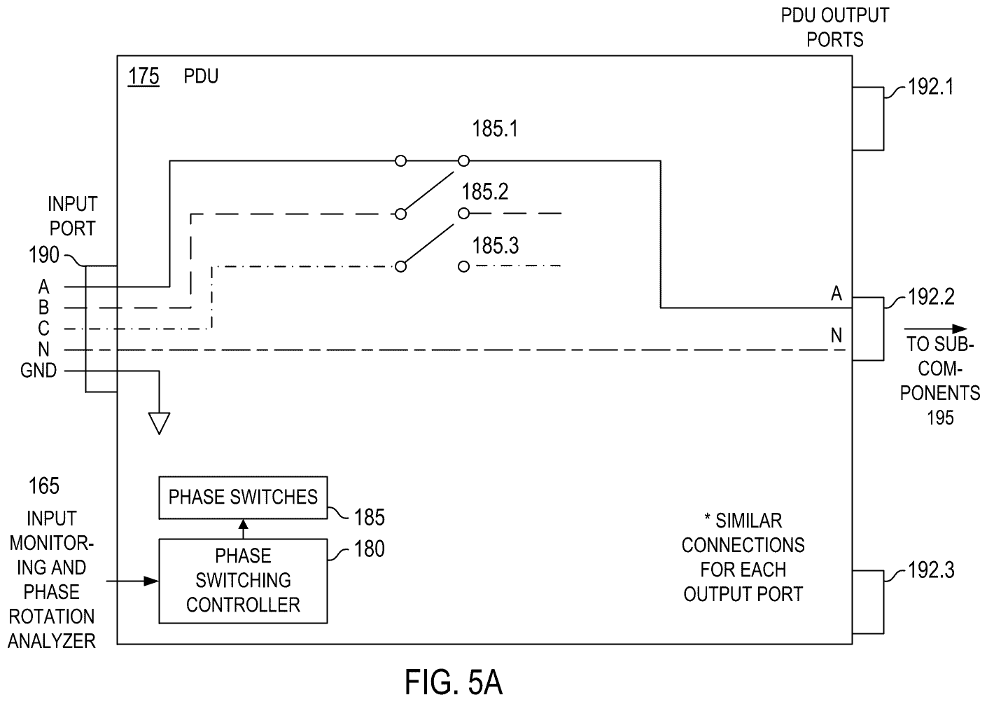

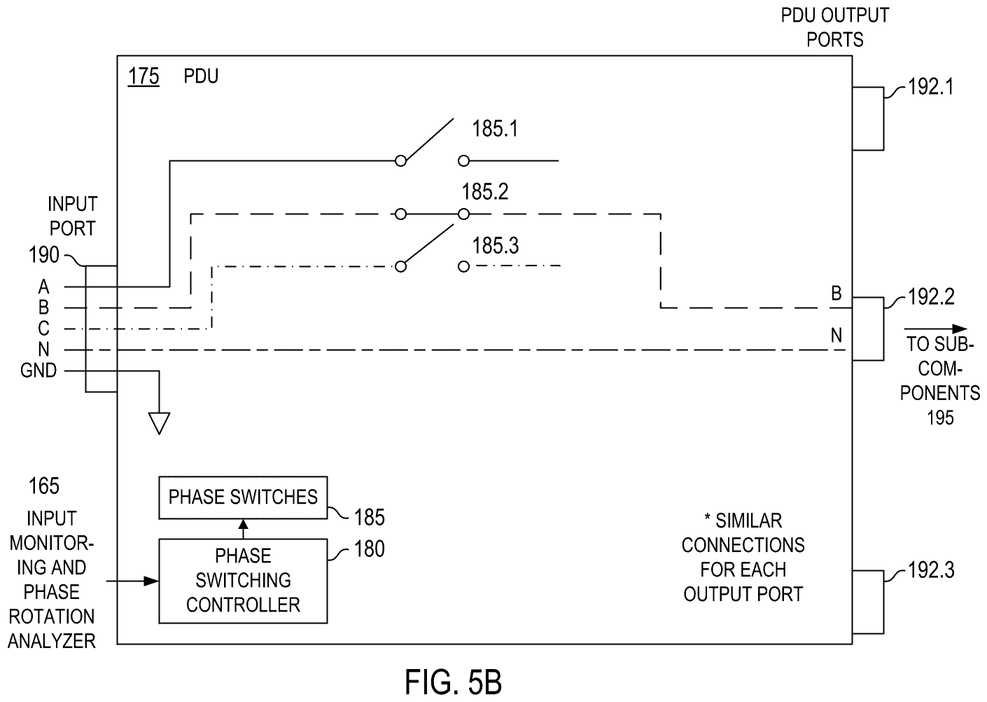

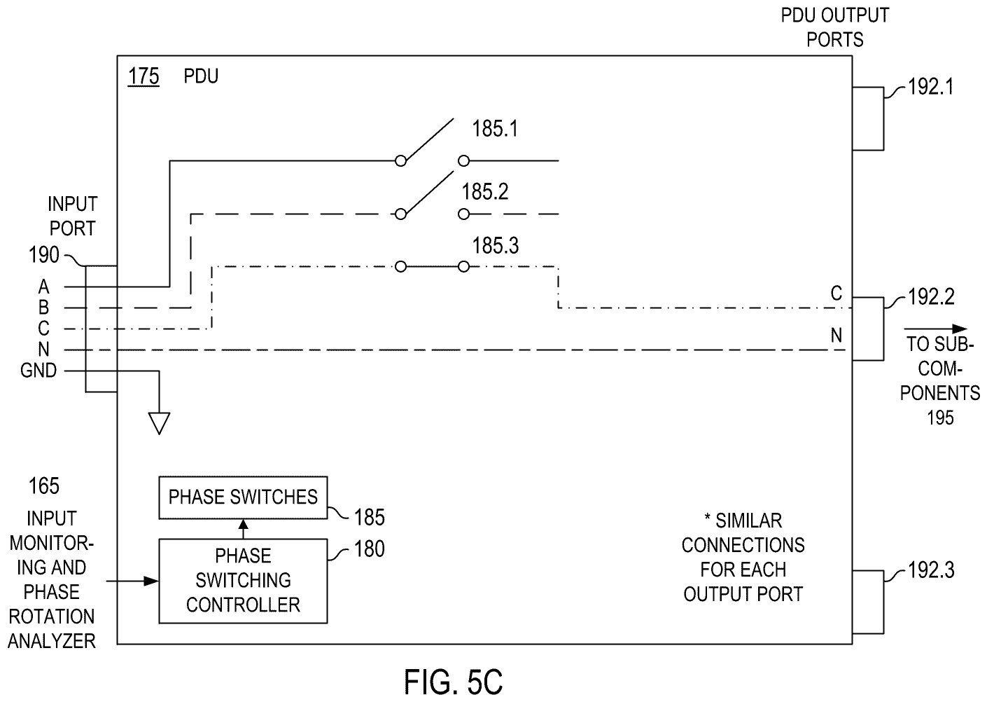

FIGS. 5A-C are block diagrams of a wye-configured PDU 175 that illustrate various switch configurations. In these FIGS., a set of three switches 185.1, 185.2, 185.3 for only one output port 192.2 is shown. However, each of the other output ports 192.1, 192.3 would have a similar set of three switches (the number of switches 185.x per output port would correspond to the number of phases (x) on the input port 190).

In FIG. 5A, the switches 185 are configured to direct phase A from the input port 190 to output port 2 192.2, and hence, to one PSU 197 connected to a particular subcomponent 195. In FIG. 5B, the switches 185 are configured to direct phase B from the input port 190 to output port 2 192.2, and in FIG. 5C, the switches 185 are configured to direct phase C from the input port 190 to output port 2 192.2.

For the example design illustrated in FIG. 1C, which shows PDUs 175 having nine output ports, a total of twenty-seven SPST switches could be used to direct any input phase from the input port 190 to any output port 192. However, this configuration may be simplified, in some embodiments, if various groups of output ports 192 are tied together. For example, the nine output ports 192 of the PDUs 175 shown in FIG. 1C may be tied together in groups of three such that an entire group of three output ports can be switched to any of the input phases, but those three output ports cannot be split apart to connect to different input phases and must always remain together. This reduces the number of switches needed, but also reduces the flexibility and may result in less-than-optimal balancing. The switch configurations shown are example embodiments—however other embodiments are also possible as well.

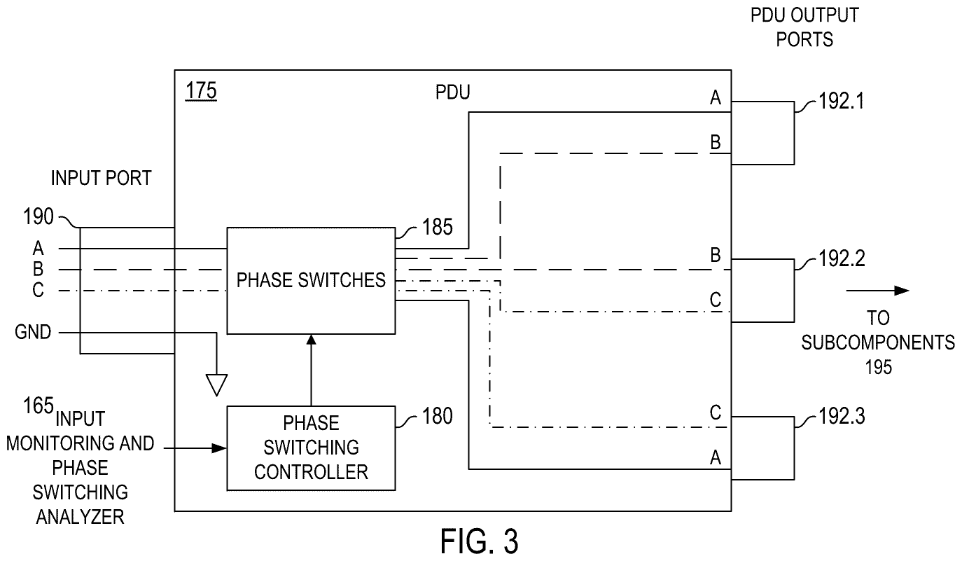

FIG. 3 is a schematic block diagram similar to FIG. 2 but describing some embodiments of an example delta-configured PDU 175 illustrating phase switches. As can be seen, the output port 192 power is attached to two of the input phases from the input port 190, as opposed to one input phase, and neutral in the wye-configured PDU shown in FIG. 2. In some embodiments, a ground may be connected at the output ports as well. The remaining aspects are similar to those of FIG. 2, and a related description is not repeated. However, the delta-configured PDU 175 requires twice as many switches for the phase switching.

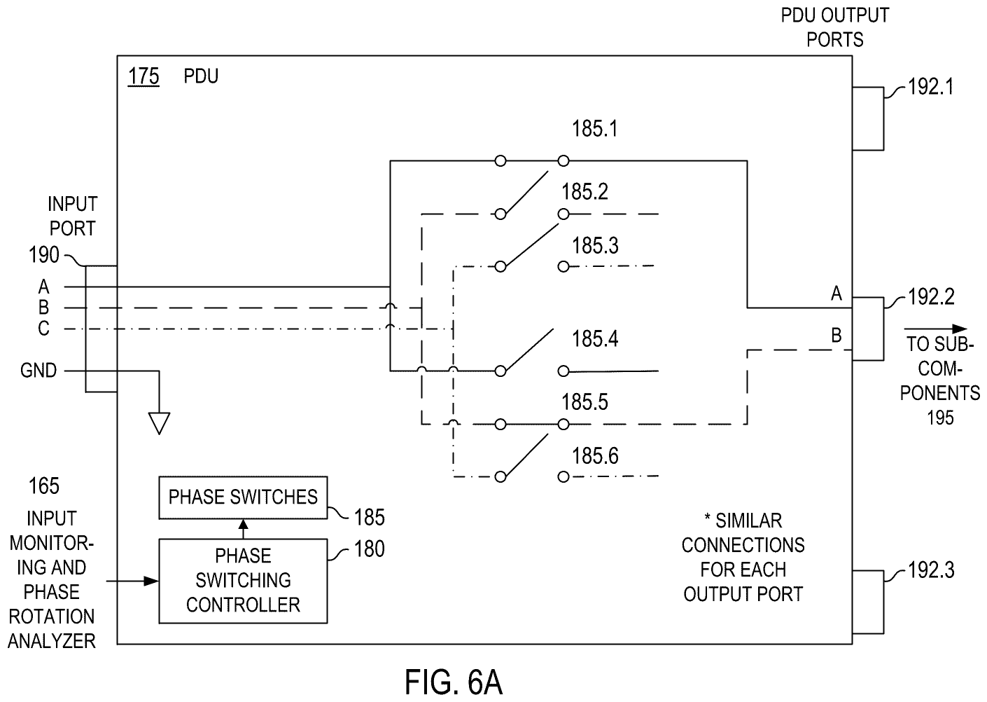

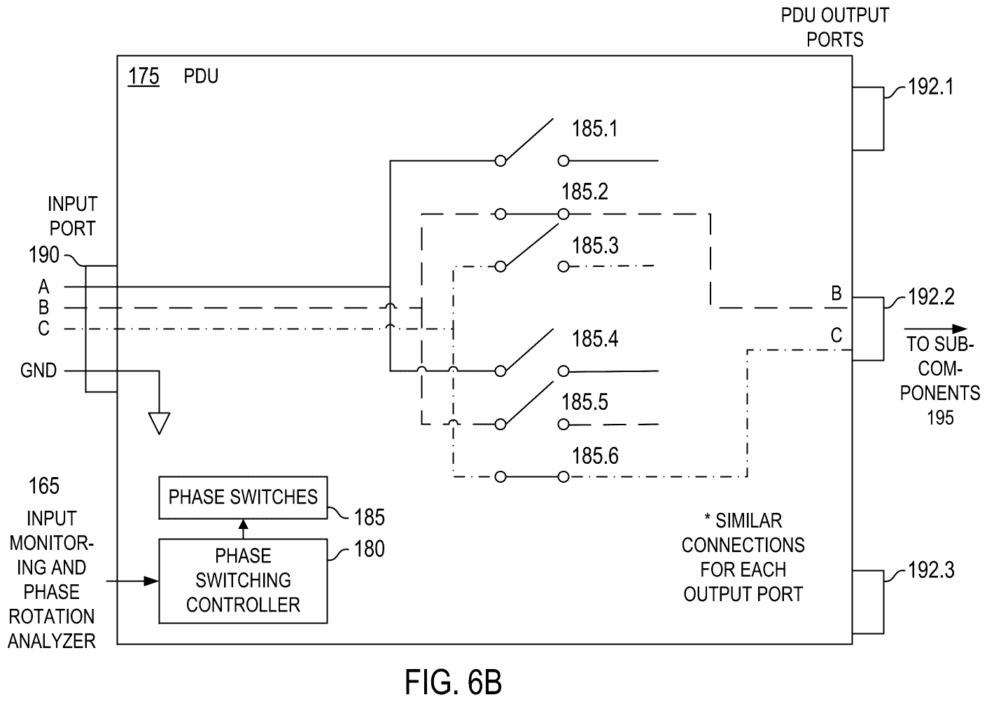

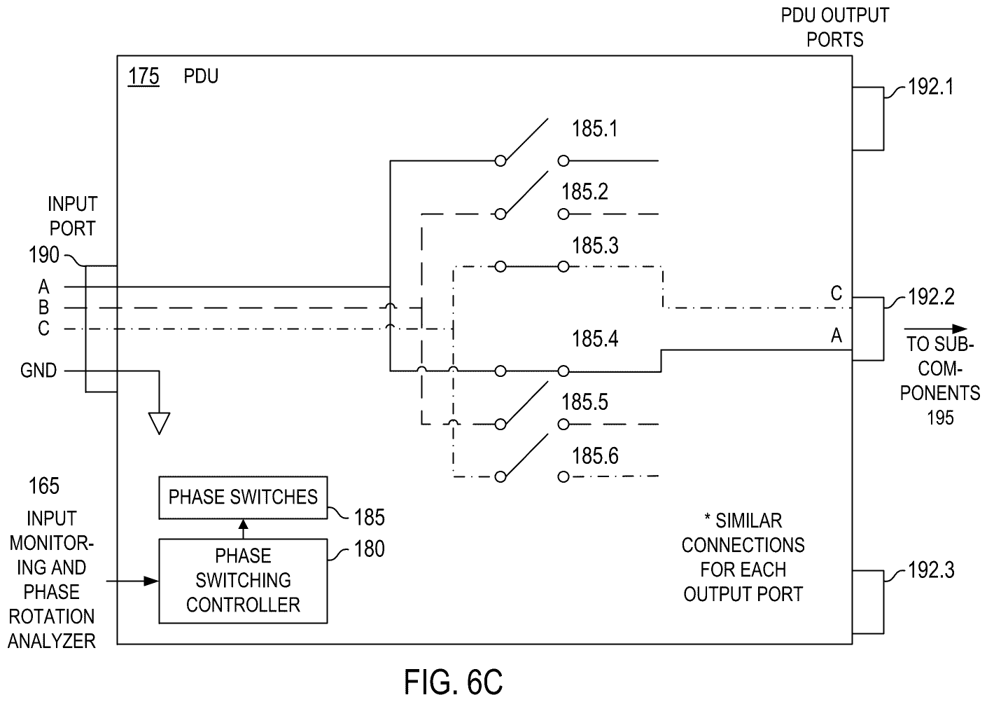

FIGS. 6A-C are block diagrams of a delta-configured PDU 175 that illustrate various switch configurations. In these FIGS., a set of six switches 185.1, 185.2, 185.3, 185.4, 185.5, 185.6 for only one output port 192.2 is shown. However, each of the other output ports 192.1, 192.3 would have a similar set of six switches (the number of switches 185.x per output port would correspond to two times the number of phases (x) on the input port 190).

In FIG. 6A, the switches 185 are configured to direct phase A from the input port 190 to one pole of the output port 2 192.2 and phase B from the input port 190 to the other pole of the output port 2 192.2, and hence, to one PSU 197 connected to a particular subcomponent 195. In FIG. 6B, the switches 185 are configured to direct phase B from the input port 190 to one pole of the output port 2 192.2 and phase C from the input port 190 to the other pole of the output port 2 192, and in FIG. 6C, the switches 185 are configured to direct phase C from the input port 190 to one pole of the output port 2 192.2 and phase A from the input port 190 to the other pole of the output port 2 192.2.

For the example design illustrated in FIG. 1C, which shows PDUs 175 having nine output ports, a total of fifty-four SPST switches could be used to direct any input phase from the input port 190 to any output port 192. However, as noted above with respect to the wye-configuration, this configuration may be simplified if various output ports 192 are tied together. For example, the nine output ports 192 of the PDUs 175 shown in FIG. 1C may be tied together in groups of three such that an entire group of three output ports can be switched to any of the input phases, but those three output ports cannot be split apart to connect to different input phases and must always remain together. This reduces the number of switches needed, but also reduces the flexibility and may result in less-than-optimal balancing. The switch configurations shown are example embodiments—however other embodiments are also possible as well.

### PSU Load Shifting

Where there are redundant PDUs 175 provided for more reliable powering of the subcomponents 195, it is possible to perform PSU 197 load shifting for further accuracy of input phase balancing using phase assignment with a PDU 175 as described above. Since each PDU 175 may be tied to other PSUs 197, it is then possible control the voltage on the PSUs 197 to current share differently, i.e., divide the current/power output of the PSUs 197 unevenly using a PSU load-shifting algorithm.

A subcomponent will draw whatever amount of power it needs to run (e.g., 2 kW). Typically, redundant PSUs 197 will split that power output evenly (i.e., 50/50 split) (e.g., with 1 kW on each PSU 197). Load shifting allows delivery of the 2 kW unevenly between the PSUs 197 (e.g., 60/40 split with 1.2 kW on one PSU and 800 W on the other PSU). The PSU 197 input is connected to the PDU output port 192, so altering the PSU input will directly impact the PDU input phase balancing depending on the switch configuration selected in the PDU 175.

If the redundant PDUs 175 are connected to the same power feed 151, the PDU phase switches 185 should not only balance power as best as possible before PSU load shifting takes place, but the phases on one PDU should be switched such that the same phase on two different PDUs 175 is not powering PSUs 197 in the same subcomponent 195. If this situation were to happen, the PSU load shifting would do nothing to help the power feed because no matter how the power was load-shifted (i.e., what power split was done), the same total power would ultimately remain on the same input phase. Thus, the system must ensure that a subcomponent 195 is powered by PDUs 175 providing power on different phases.

Table 3D, below, illustrates an example of using this load shifting on the configuration described above with Table 3A.

TABLE 3D
Power Consumption/Limits for Fully-Loaded Equipment Rack
Post-Move (Post-Switch) (Load Shifted)

| | | | | Power | | | Power | | | |
|---|---|---|---|---|---|---|---|---|---|---|
| | | | | per | | | per | | | PSU load |
| Total | | | Power | port | | Φ | port | Φ | | balance |
| 3Φ | | | per | on | PDU- | connection | on | connection | PDU- | (PDU-A1 |
| rack | Power | Sub- | sub- | PDU- | A1 | on PDU- | PDU- | on PDU- | A2 | PSU/PDU- |
| power | per Φ | comp. | comp | A1 | port | A1 | A2 | A2 | port | A2 PSU) |
| 14400 | 4800 | IT1 | 2500 | 1300 | 1 | A | 1200 | C | 1 | 52%/48% |
| | (Φ_{A}) | IT2 | 1600 | 800 | 2 | A | 800 | C | 2 | 50%/50% |
| | (33.33%) | IT3 | 100 | 50 | 3 | A | 50 | C | 3 | 50%/50% |
| | 4800 | IT4 | 100 | 50 | 4 | A | 50 | B | 4 | 50%/50% |
| | (Φ_{B}) | IT5 | 2500 | 1250 | 5 | B | 1250 | A | 5 | 50%/50% |
| | (33.33%) | IT6 | 2500 | 1200 | 6 | B | 1300 | A | 6 | 48%/52% |
| | 4800 | IT7 | 100 | 50 | 7 | A | 50 | B | 7 | 50%/50% |
| | (Φ_{C}) | IT8 | 2500 | 1500 | 8 | C | 1000 | B | 8 | 60%/40% |
| | (33.33%) | IT9 | 2500 | 1250 | 9 | C | 1250 | B | 9 | 50%/50% |

Table 3D is similar to Table 3A (illustrating the fully-loaded equipment rack) with the following exception. The input monitoring and phase switching analyzer 165 may determine the ideal power per phase, as described above, as 4.8 kW. Considering the information from Table 3A above, it may determine that if it could “take” 600 W from Phase A and redistribute it evenly across Phases B and C (“give” 300 W to each), it could ensure a balanced system.

In this case, PDU-A1 output port 4 has been switched from Phase B to Phase A, and PDU-A1 output port 7 has been switched from Phase C to Phase A. PDU-A2 output ports 1-3 have all been switched from Phase A to Phase C. PDU-A2 output ports 5 and 6 have been switched from Phase B to Phase A, and PDU-A2 output ports 7-9 have been switched from Phase C to Phase B.

Table 3D further reflects a PSU load balancing to accompany this shifting of the phases. A 50%/50% PSU load balance remains proper on IT2-IT5, IT7, and IT9. However, with the new phase assignments, the PSU load balance is shifted on IT1, IT6, and IT8. On IT1, PDU-A1 PSU provides 52% of the power, and PDU-A2 PSU provides 48% of the power. On IT6, PDU-A1 PSU provides 48% of the power, and PDU-A2 PSU provides 52% of the power. Finally, on IT8, PDU-A1 PSU provides 60% of the power, and PDU-A2 PSU provides 40% of the power.

Note that in Table 3D, the output ports for PDU-A2 175 have been shifted to no longer provide the same phases for the corresponding output ports of PDU-A1 175. Also, the PSU 197 load-shifting algorithm directs the load to be spread the PSUs 197 for the subcomponent ITx 195 so that the PDU port shifts from one PDU to the other do not have to move in tandem. Note that without the ability to shift the PDU phases on the input, the benefit of the PSU 197 load shifting would not be realized, i.e., the shifting would be within a given drawer, but all of the power would still be provided on a single phase.

The PSU load shifting of only a portion of the power was illustrated above with respect to Table 3D for the sake of simplicity, but this example may also illustrate the iterative and repetitive nature of operations. The above process may be repeated multiple times until an optimal (or at least satisfactory) balancing of the power, according to, e.g., some predefined thresholds is achieved (e.g., +/−2%, +/−10%). The same or different thresholds may be employed to determine either or both of the phase switching and load balancing functions described herein.

FIG. 4 is a flowchart illustrating an example process 400 for phase balancing using the intelligent phase assignment and PSU load shifting, according to some embodiments of the PPSLSS 160. In some embodiments, the process 400 shown in FIG. 4 may be executed by any or all of elements within the system controller 162, the PDU 175, and the PSU 197/subcomponents 195, that are in communication with one another via the network 155 and other communication interfaces, such as busses and the like. These may all reside within the equipment rack 154.

The process 400 is broken down into two primary stages: 1) the PDU power monitoring and phase switching stage, which comprises operations 410-425; and 2) the PSU load shifting stage, which comprises operation 450. Although operation of the components of the PPSLSS 160 have been described in some detail above, the following is a brief discussion of the operations comprising the process 400.

In operation 410, the data for determining the power for each of the input phases to PDU 175 is measured by a measuring device 183, which may reside on the PDU 175. This data is provided to the input monitoring and phase switching analyzer 165. In operation 415, the total power across all phases is determined, and a target power per phase may be determined by dividing the total power by the number of available phases. In operation 420, if the phases are determined to not be unbalanced (420: NO), then the process loops back to operation 410. As noted above, this repetition may, in practice, occur on the order of a few times per hour to a few times per day, but nothing in the invention limits this frequency in any way.

If the phases are determined to be unbalanced (420: YES), then a determination is made by the input monitoring and phase switching analyzer 165 in operation 425 to redirect an input phase to a PDU output port 192 in a way that can better balance the power across phases. This type of an optimization may, e.g., use a calculation of a combined deviation from the target per-phase power values determined in operation 415.

The input monitoring and phase switching analyzer 165 may work in conjunction with the PSU load-shifting control 167, and when phases differ on PDUs 175 for a subcomponent 195, in operation 450, power load shifting is performed on the PSUs 197 by controlling PSU current to spread current between redundant PSUs 197 providing power to the subcomponent 195 to ultimately achieve better phase balancing at the power feed supplying power to redundant PDUs 175.

Although the illustrative examples above have focused on performing balancing of phase power across an equipment rack 154, the same principles may be applied across a plurality of equipment racks 154, across an entire data center 152, or even across multiple data centers 152 that share a common source of phased power.

### Technical Application

The one or more embodiments disclosed herein accordingly provide an improvement to technology, namely to improving power distribution to loads across phases by using a PDU having intelligent switching capabilities, and a PSU having load shifting capabilities.

### Examples

According to an aspect of the invention, Example 1 is a method for balancing phase power in a power distribution system. The method comprises performing the following operations dynamically and repeatedly, during operation of subcomponents receiving power from a plurality of redundant intelligent PDUs. The method comprises monitoring a plurality of input phases of the intelligent PDUs for power values associated with the input phases that provide power to the subcomponents through the PDUs. The method then comprises determining target per-phase power value based on the input phase power values by summing a total input power to each PDU in the redundant set of PDUs and dividing the summed total input power by a number of the phases. The method further comprises determining when the input phases are not balanced according to a predefined threshold or rule that uses the target per-phase power value, and redirecting an input phase at an input port to an output port of at least one of the PDUs using a switch on the at least one PDU to bring the not-balanced phases closer to being balanced phases by reducing a difference of phase powers to the target per-phase power value. A first phase of at least one of the PDUs connected to a first subcomponent differs from a second phase of a redundant PDU connected to the first subcomponent. The method then comprises performing load shifting on the power supply units (PSUs) associated with the redundant PDUs to achieve an overall improved input phase power balance across all redundant PDUs.

The technical effect is to allow a balancing of phase power which makes a better and more efficient use of power resources in a power delivery system. By performing both phase switching by PDUs and load shifting by PSUs, an optimum or near optimum phase balance can be achieved.

According to an aspect of the invention, Example 2 is a method according to Example 1, where the subcomponent power values are determined from measured values of voltage and current. Measuring these values allows for an automatic and dynamic update to be implemented. Advantageously, the system can adapt to changes related to power demands over time.

According to an aspect of the invention, Example 3 is a method according to Example 2, where the measured values of voltage and current are obtained by a measuring device on at least one of the redundant PDUs that monitors a respective PDU output port. Locating the measuring device on a PDU allows the power determination to be made accurately within the system. Advantageously, the system can use accurate power determinations to better balance the phases supplied to the subcomponents.

According to an aspect of the invention, Example 4 is a method according to Examples 2 and 3, where the measured values of voltage and current are obtained by a measuring device on at least one of the PSUs that monitors a respective PSU input port. Locating the measuring device on a PSU allows the power determination to be made accurately within the system. Advantageously, the system can use accurate power determinations to better balance the phases supplied to the subcomponents.

According to an aspect of the invention, Example 5 is a method according to Examples 1 through 4, the method further comprising measuring PDU phase inputs on each PDU powering a same connected group of subcomponents. The grouping of subcomponents can result in consolidation of resources and require fewer supporting components. Advantageously, this can reduce cost and complexity of the overall system.

According to an aspect of the invention, Example 6 is a method according to Examples 1 through 5, where the redirecting of the input phase is based on a level of phase power imbalance. Redirection of the input phase may be considered a more coarse phase balancing feature, whereas the load shifting on the PSUs can be considered a more precision phase balancing feature. These two techniques, when combined, can produce an optimum or near optimum phase balancing.

According to an aspect of the invention, Example 7 is a method according to Examples 1 through 6, where the phase power is provided in a wye configuration. A wye configuration is a common three-phase configuration for supplying power.

According to an aspect of the invention, Example 8 is a method according to Example 7, where a number of the physical switches in the switch used to redirect the input phase is a product of a number of input phases times a number of output ports on a respective PDU of the redundant intelligent PDUs. The use of this switch configuration in a wye-connected system can provide maximum flexibility for switching the phases to the output ports of the PDU.

According to an aspect of the invention, Example 9 is a method according to Examples 1 through 6, where the phase power is provided in a delta configuration. A delta configuration is a common three-phase configuration for supplying power.

According to an aspect of the invention, Example 10 is a method according to Example 9, where a number of the physical switches in the switch used to redirect the input phase is twice a product of a number of input phases times a number of output ports on a respective PDU of the redundant intelligent PDUs. The use of this switch configuration in a delta-connected system can provide maximum flexibility for switching the phases to the output ports of the PDU.

According to an aspect of the invention, Example 11 is a method according to Examples 1 through 10, where the power balancing is performed by controlling a current output on the PSUs to spread the current between one of the two or more PSUs. Locating the load shifting on the PSU and using it to spread current simplifies the load shifting feature and allows a clean interface to implement the load shifting for the subcomponents.

According to an aspect of the invention, Example 12 is a system for balancing phase power in a power distribution system, comprising a memory, and a processor that is configured to dynamically and repeatedly perform the operations described in the method Examples 1 through 11 above.

According to an aspect of the invention, Example 13 is a computer program product is also provided for balancing phase power in a power distribution system, the computer program product comprising one or more computer readable storage media, and program instructions collectively stored on the one or more computer readable storage media, the program instructions comprising program instructions to perform the operations described in the method Examples 1 through 11 above when executed on one or more processors.

What is claimed is:

1. A method for balancing phase power in a power distribution system, comprising:
dynamically and repeatedly, during operation of subcomponents receiving power from a plurality of redundant intelligent PDUs:
monitoring a plurality of input phases of the intelligent PDUs for power values associated with the input phases that provide power to the subcomponents through the PDUs;
determining target per-phase power value based on the input phase power values by summing a total input power to each PDU in a redundant set of PDUs and dividing the summed total input power by a number of the phases;
determining when the input phases are not balanced according to a predefined threshold or rule that uses the target per-phase power value;
redirecting an input phase at an input port to an output port of at least one of the plurality of redundant intelligent PDUs using a switch on the at least one PDU to bring the not-balanced phases closer to being balanced phases by reducing a difference of phase powers to the target per-phase power value, wherein a first phase of at least one of the plurality of redundant intelligent PDUs connected to a first subcomponent differs from a second phase of a redundant PDU of the plurality of redundant intelligent PDUs connected to the first subcomponent; and
performing load shifting on a power supply units (PSUs) associated with the redundant PDUs to achieve an overall improved input phase power balance across all redundant PDUs.

2. The method of claim 1, wherein subcomponent power values are determined from measured values of voltage and current.

3. The method of claim 2, wherein the measured values of voltage and current are obtained by a measuring device on at least one of the redundant PDUs that monitors a respective PDU output port.

4. The method of claim 2, wherein the measured values of voltage and current are obtained by a measuring device on at least one of the PSUs that monitors a respective PSU input port.

5. The method of claim 1, further comprising measuring PDU phase inputs on each PDU powering a same connected group of subcomponents.

6. The method of claim 1, wherein the redirecting of the input phase is based on a level of phase power imbalance.

7. The method of claim 1, wherein the phase power is provided in a wye configuration.

8. The method of claim 7, wherein a number of physical switches in the switch used to redirect the input phase is a product of a number of input phases times a number of output ports on a respective PDU of the redundant intelligent PDUs.

9. The method of claim 1, wherein the phase power is provided in a delta configuration.

10. The method of claim 9, wherein a number of physical switches in the switch used to redirect the input phase is twice a product of a number of input phases times a number of output ports on a respective PDU of the redundant intelligent PDUs.

11. The method of claim 1, wherein the phase power balancing is performed by controlling a current output on the PSUs to spread current between one of two or more PSUs.

12. A system for balancing phase power in a power distribution system, comprising:
a memory; and
a processor that is configured to dynamically and repeatedly, during operation of subcomponents receiving power from a plurality of redundant intelligent PDUs:
monitor a plurality of input phases of the intelligent PDUs for power values associated with the input phases that provide power to the subcomponents through the PDUs;
determine target per-phase power value based on the input phase power values by summing a total input power to each PDU in a redundant set of PDUs and dividing the summed total input power by a number of the phases;
determine when the input phases are not balanced according to a predefined threshold or rule that uses the target per-phase power value;
redirect an input phase at an input port to an output port of at least one of the plurality of redundant intelligent PDUs using a switch on the at least one of the plurality of redundant intelligent PDUs to bring the not-balanced phases closer to being balanced phases by reducing a difference of phase powers to the target per-phase power value, wherein a first phase of at least one of the plurality of redundant intelligent PDUs connected to a first subcomponent differs from a second phase of a redundant PDU of the plurality of redundant intelligent PDUs connected to the first subcomponent; and
perform load shifting on the power supply units (PSUs) associated with the redundant PDUs to achieve an overall improved input phase power balance across all redundant PDUs.

13. The system of claim 12, wherein subcomponent power values are determined from measured values of voltage and current.

14. The system of claim 13, wherein the measured values of voltage and current are obtained by a measuring device on at least one of the redundant PDUs that monitors a respective PDU output port.

15. The system of claim 13, wherein the measured values of voltage and current are obtained by a measuring device on at least one of the PSUs that monitors a respective PSU input port.

16. The system of claim 12, wherein the redirecting of the input phase is based on a level of phase power imbalance.

17. The system of claim 12, wherein:
the phase power is provided in a wye configuration; and
a number of physical switches in the switch used to redirect the input phase is a product of a number of input phases times a number of output ports on a respective PDU of the redundant intelligent PDUs.

18. The system of claim 12, wherein:
the phase power is provided in a delta configuration; and
a number of physical switches in the switch used to redirect the input phase is twice a product of a number of input phases times a number of output ports on a respective PDU of the redundant intelligent PDUs.

19. The system of claim 12, wherein the power balancing is performed by controlling a current output on the PSUs to spread current between one of the two or more PSUs.

20. A computer program product for balancing phase power in a power distribution system, the computer program product comprising:
one or more computer readable storage media, and program instructions collectively stored on the one or more computer readable storage media, the program instructions comprising program instructions to dynamically and repeatedly, during operation of subcomponents receiving power from a plurality of redundant intelligent PDUs:
monitor a plurality of input phases of the intelligent PDUs for power values associated with the input phases that provide power to the subcomponents through the PDUs;
determine target per-phase power value based on the input phase power values by summing a total input power to each PDU in a redundant set of PDUs and dividing the summed total input power by a number of the phases;
determine when the input phases are not balanced according to a predefined threshold or rule that uses the target per-phase power value;
redirect an input phase at an input port to an output port of at least one of the plurality of redundant intelligent PDUs using a switch on the at least one of the plurality of redundant intelligent PDUs to bring the not-balanced phases closer to being balanced phases by reducing a difference of phase powers to the target per-phase power value, wherein a first phase of at least one of the plurality of redundant intelligent PDUs connected to a first subcomponent differs from a second phase of a redundant PDU of the plurality of redundant intelligent PDUs connected to the first subcomponent; and
perform load shifting on the power supply units (PSUs) associated with the redundant PDUs to achieve an overall improved input phase power balance across all redundant PDUs.
